(19) United States
(12) Patent Application Publication
(10) Pub. No.: US 2012/0100760 A1
(43) Pub. Date: Apr. 26, 2012

(54) ELECTRICAL CONNECTOR HAVING AN IMPROVED REAR COVER

(75) Inventors: SU-FENG LIU, Kunshan (CN); CHIN-TE LAI, New Taipei (TW); HAI-SONG CHEN, Kunshan (CN)

(73) Assignee: HON HAI PRECISION INDUSTRY CO., LTD., New Taipei (TW)

(21) Appl. No.: 13/282,384

(22) Filed: Oct. 26, 2011

(30) Foreign Application Priority Data
Oct. 26, 2010 (CN) 201010519512.0

(51) Int. Cl. H01R 24/28

(52) U.S. Cl. 439/660

(57) ABSTRACT

An electrical connector comprises a housing defining a basic portion and a mating portion extending forwardly from the basic portion, the basic portion comprising a main portion and a pair of arms extending rearwardly from the main portion, a first slot being defined on an inner surface of each arm; a spacer having a lower portion, a pair of retaining portions receiving in the first slots and a supporting portion located on the retaining portion; a plurality of terminals received in the housing and each terminal defining a soldering portion located on the supporting portion; and a rear cover located between the arms and defining an upper wall, a rear wall and a pair of lateral walls, each lateral wall defining a rib received in the arm. The supporting portion is located between the lower portion of the spacer and the upper wall.

### FIELD OF THE INVENTION

The present invention relates to an electrical connector, and more particularly to an electrical connector having an improved rear cover.

### DESCRIPTION OF PRIOR ART

Serial Advanced Technology Attachment (SATA) connectors are widely used in electric devices such as notebooks. A SATA connector always comprises a housing, a plurality of conducts received in the housing, a spacer supporting the conducts and a rear cover. The housing defines a basic portion and a mating portion extending forwardly from the basic portion. The basic portion defines a plurality of retaining holes retaining the conducts. The mating portion defines a plurality of receiving grooves communicated with the retaining holes, respectively. The conduct comprises a retaining portion retained in the retaining hole and a touching portion extending forwardly from the retaining portion and received in the receiving groove. The spacer supports a soldering portion behind the retaining portion. The rear cover is fastened on a rear portion of the housing, and the spacer is received in the rear cover. So, the rear cover must define a space for receiving the spacer. Thus, the rear cover may be too big.

As discussed above, an improved electrical connector overcoming the shortages of existing technology is needed.

### SUMMARY OF THE INVENTION

Accordingly, an object of the present invention is to provide a lower profile electrical connector having an improved rear cover.

In order to achieve the above-mentioned objects, an electrical connector comprises a housing defining a basic portion and a mating portion extending forwardly from the basic portion, the basic portion comprising a main portion and a pair of arms extending rearwardly from the main portion, a first slot being defined on an inner surface of each arm; a spacer having a lower portion, a pair of retaining portions receiving in the first slots and a supporting portion located on the retaining portion; a plurality of terminals received in the housing and each terminal defining a soldering portion located on the supporting portion; and a rear cover located between the arms and defining an upper wall, a rear wall and a pair of lateral walls, each lateral wall defining a rib received in the arm. The supporting portion is located between the lower portion of the spacer and the upper wall.

Other objects, features and advantages of the invention will be apparent from the following detailed description taken in connection with the accompanying drawings.

### BRIEF DESCRIPTION OF THE DRAWINGS

FIG. 1 is a perspective view of an electrical connector in accordance with the present invention;

FIG. 2 is a view similar to FIG. 1, but from another aspect;

FIG. 3 is a partly assembled, perspective view of the electrical connector shown in FIG. 1;

FIG. 4 is an exploded, perspective view of the electrical connector shown in FIG. 1;

FIG. 5 is a view similar to FIG. 4, but from another aspect; and

FIG. 6 is a view similar to FIG. 5, but from the third aspect.

### DETAILED DESCRIPTION OF PREFERRED EMBODIMENTS

Reference will now be made to the drawing figures to describe the present invention in detail.

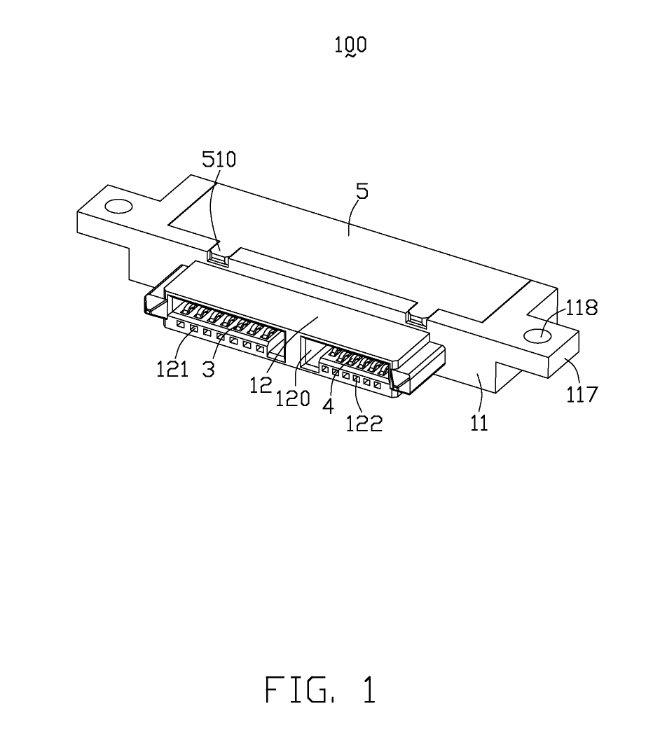

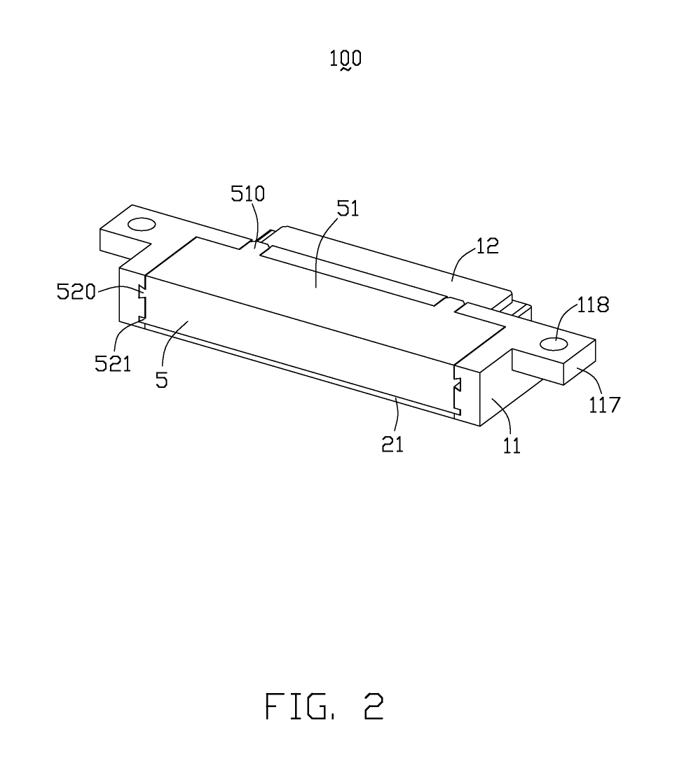

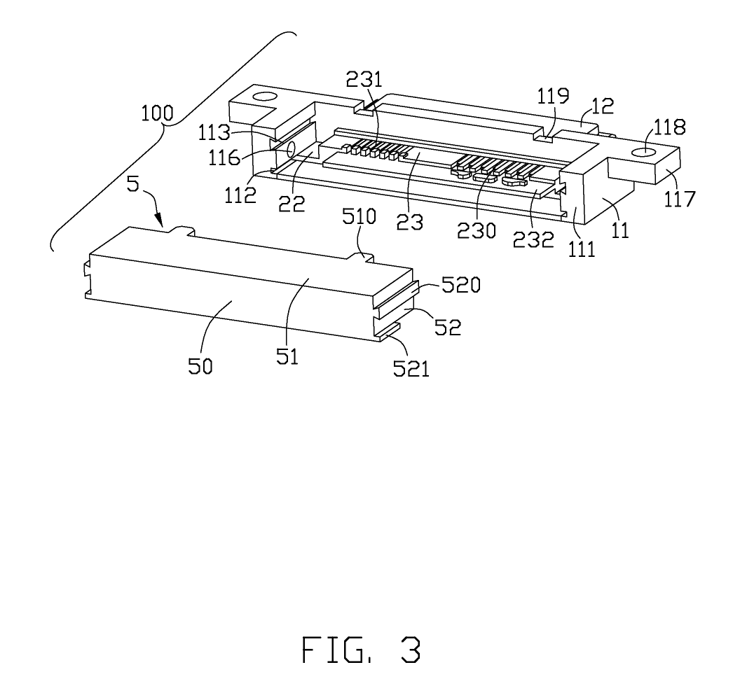

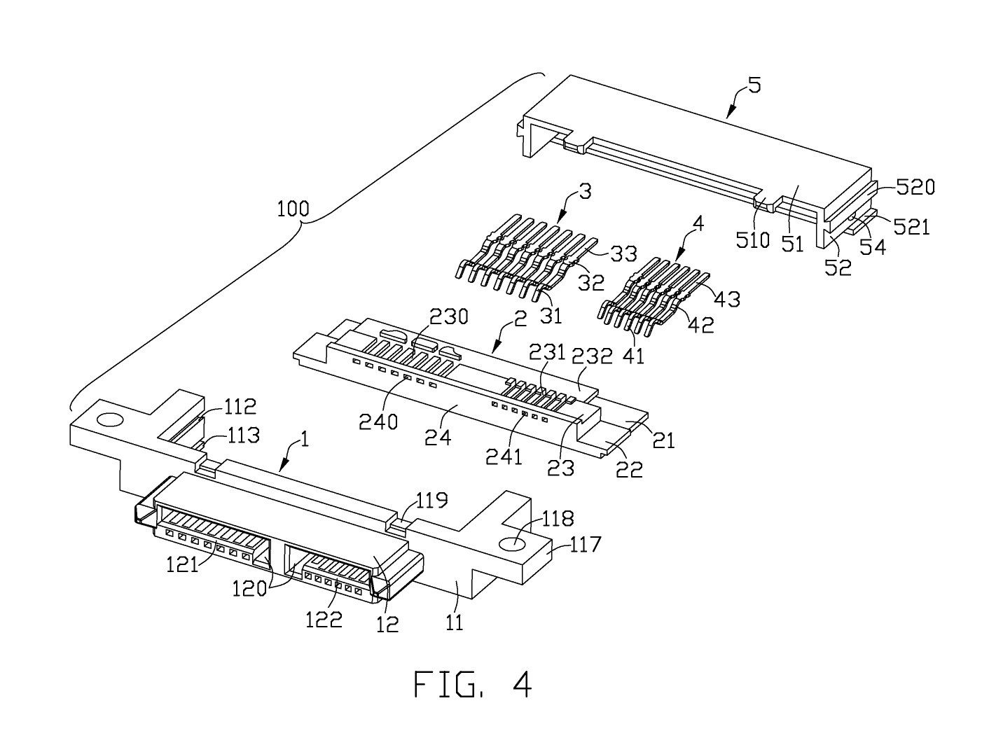

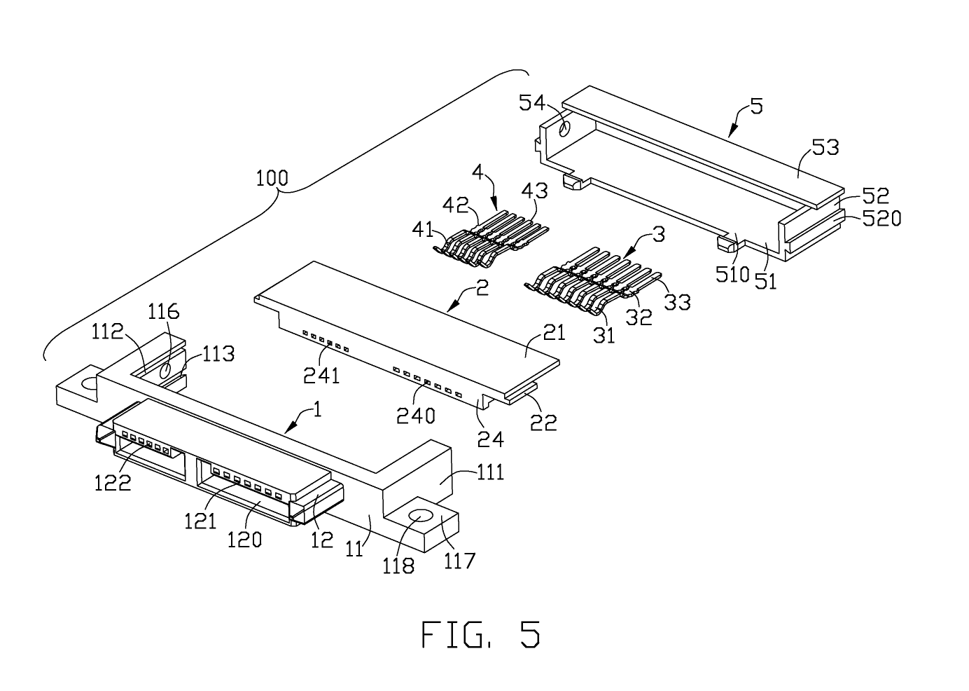

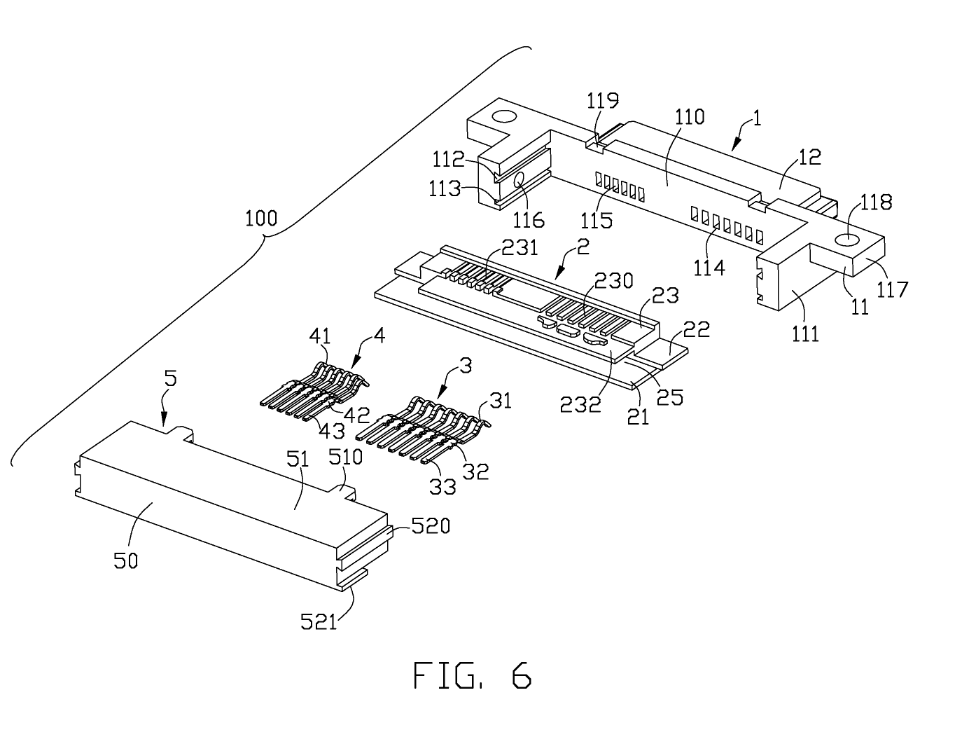

Referring to FIGS. 1 to 6, an electrical connector 100 in accordance with the present invention comprises a housing 1, a spacer 2 assembled in the housing 1, a plurality of first terminals 3 received in the housing 1, a plurality of second terminals 4 received in housing 1 and a rear cover 5 located behind the housing 1.

The housing 1 comprises a basic portion 11 and a mating portion 12 extending forwardly from the basic portion 11. The basic portion 11 defines a main portion 110 connected to the mating portion 12. A pair of arms 111 are extended rearwardly from two sides of the main portion 110 along a mating direction of the electrical connector 100, respectively. Each arm 111 defines a first slot 112 recessing inwardly from an inner surface thereof and a second slot 113 recessing inwardly from the inner surface thereof The cross-section of the first slot 112 is rectangular, and the cross-section of the second slot 113 is chevrons. The first slot 112 and the second slot 113 respectively extend along the mating direction. One of arms 111 also defines a cable hole 116 for making a cable (not shown) can pass therethrough to connect to the first terminals 3 and the second terminals 4. The main portion 110 defines a plurality of first receiving holes 114 and second receiving holes 115 for receiving the first terminals 3 and the second terminals 4, respectively. A pair of wings 117 are respectively located at two side of the main portion 110. A mounting hole 118 is defined on the wing 117 for retaining the electrical connector 100. The main portion 110 also defines a pair of slits 119 located on the upper surface thereof and run through the front and rear surfaces thereof

The mating portion 12 defines two receiving grooves 120. A plurality of first receiving passageways 121 and second receiving passageways 122 are respectively defined in the receiving grooves 120. The first receiving passageway 121 is communicated with the first receiving hole 114, and the second receiving passageway 122 is communicated with the second receiving hole 115.

The spacer 2 comprises a lower portion 21, a retaining portion 22 located on the lower portion 21 and a supporting portion 23 located on the retaining portion 22. The width of the retaining portion 22 is wider than the width of the supporting portion 23. The supporting portion 23 defines a plurality of first notches 230, a plurality of second notches 231 and a flat portion 232 extending rearwardly from the rear surface thereof . A front wall 24 is defined beyond the upper surface of the supporting portion 23. The front wall 24 defines a plurality of first through holes 240 communication with the first notches 230 and second through holes 241 communication with the second notches 231. A gap 25 is formed between the flat portion 232 and the lower portion 21.

Each first terminal 3 comprises a first connecting portion 32 having a hangnail (not label), a first touching portion 31 extending forwardly from the first connecting portion 32 and a first soldering portion 33 extending rearwardly from the first connecting portion 32.

Each second terminal 4 comprises a second connecting portion 42 having a hangnail (not label), a second touching portion 41 extending forwardly from the second connecting portion 42 and a second soldering portion 43 extending rearwardly from the second connecting portion 42.

The rear cover 5 comprises an upper wall 51, a lower wall 53 and a pair of lateral walls 52 connecting the upper wall 51 to the lower wall 53. The lateral wall 52 defines a protrusion 520 extending along a front-to-rear direction and connecting the upper wall 51 to the lower wall 53. The shape of the cross-section of the protrusion 520 is as same as the shape of the first slot 112. The lateral wall 52 also defines a rib 521 alignment with the lower wall 53. A cable hole 54 is defined on the lateral wall 52. The rear cover 5 also defines a pair of hooks 510 extending forwardly from the upper wall 51 along the mating direction.

In assembly, the first touching portion 31 passes through the first receiving hole 114 and is received in the first receiving passageway 121, and the first connecting portion 32 is received in the first receiving hole 114. The second touching portion 41 passes through the second receiving hole 115 and is received in the second receiving passageway 122, and the second connecting portion 42 is received in the second receiving hole 115.

The retaining portions 22 of the spacer 2 are assembled in the first slots 112 of the arms 111 of the housing 1. The lower portion 21 is retained between the arms 111, and the front surface of the spacer 2 is attached to the basic portion 11 of the housing 1. The lower surface of the lower portion 21 is alignment to the lower surface of the arms 111. The front surface of the front wall 24 is attached to basic portion 11. The first soldering portion 33 is pass through the first through hole 240 and received in the first notch 230. The second soldering portion 43 is pass through the second through hole 241 and received in the second notch 231.

The rear cover 5 is located behind the spacer 2 and between the arms 111. The protrusion 520 is received in the second slot 113. The hooks 510 are fastened on the slits 119, respectively. The rib 521 is received in the first slot 112 and located behind the retaining portion 22. The front surface of the rib 521 is attached to the rear surface of the retaining portion 22. The cable hole 54 is alignment to the cable hole 116 for the cable (not shown) being through. The outer surface of the upper wall 51 is alignment to the upper surfaces of the arms 111. The outer surface of the lower wall 53 is alignment to the lower surfaces of the arms 111 and the spacer 2. The rear surface of the lower portion 21 of the spacer 2 is alignment to the outer surface of the rear wall 52 of the rear cover 5.

The method that both the rear cover 5 and the spacer 2 are assembled on the housing 1 along the same direction can make the operation conveniently. The rear cover 5 and the spacer 2 together form an outer cover of the electrical connector 100. The spacer 2 is as a wall of the rear cover 5 for enclosing the terminals, it is can reduce the size of the electrical connector 100.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. An electrical connector, comprising:
a housing defining a basic portion and a mating portion extending forwardly from the basic portion, the basic portion comprising a main portion and a pair of arms extending rearwardly from the main portion, a first slot being defined on an inner surface of each arm;
a spacer having a lower portion, a pair of retaining portions received in the first slots and a supporting portion located on the retaining portion;
a plurality of terminals received in the housing, each terminal defining a soldering portion located on the supporting portion; and
a rear cover located between the arms and defining an upper wall, a rear wall and a pair of lateral walls, each lateral wall defining a rib received in the arm;
wherein the supporting portion is located between the lower portion of the spacer and the upper wall.

2. The electrical connector as recited in claim 1, wherein the rear cover further defines a lower wall opposite to the upper wall and located between the lower portion of the spacer and the upper wall of the rear cover.

3. The electrical connector as recited in claim 1, wherein the ribs are received in the first slots of the arms, respectively.

4. The electrical connector as recited in claim 4, wherein each rib is attached to the retaining portion.

5. The electrical connector as recited in claim 1, wherein a pair of protrusions are defined on the lateral walls of the rear cover, respectively.

6. The electrical connector is recited in claim 5, wherein the arms define a pair of second slots corresponded to the protrusions, respectively, and the protrusion is received in the second slot.

7. The electrical connector is recited in claim 1, wherein the main portion defines a pair of slits, and the rear cover defines a pair of hooks fastened on the slits, respectively.

8. The electrical connector is recited in claim 1, wherein the rear surface of the lower portion of the spacer is alignment to the outer surface of the rear wall of the rear cover.

9. The electrical connector is recited in claim 8, wherein the rear cover is located on the spacer, and the lower surface of the rear cove is located on the upper surface of the lower portion of the space.

10. The electrical connector is recited in claim 1, wherein the lower surface of the lower portion is alignment to the lower surface of the arms.

11. The electrical connector is recited in claim 1, wherein the upper surface of the upper wall of the rear cover is alignment to the upper surface of the arms.

12. The electrical connector is recited in claim 11, wherein the lateral wall defines a cable hole for providing passing through for a cable.

13. An electrical connector, comprising:
a housing defining a basic portion, a mating portion extending forwardly from the basic portion and a pair of arms extending rearwardly from the basic portion;
a plurality of terminals received in the housing, each terminal defining a touching portion located in the mating portion of the housing and a soldering portion for soldering a cable;
a spacer retained between the arms of the housing and having a lower portion; and
a rear cover installed between the arms from a rear-to-front direction;
wherein the soldering portion is supported on the spacer and located between the arms; the rear cover has an upper wall fastened to the basic portion; the lower portion of the spacer and the upper wall of the rear cover are located on two sides of upper and lower surface of the arms, respectively, and together with the arms for surrounding the soldering portion.

14. The electrical connector is recited in claim 13, wherein the rear cover further defines a pair of lateral wall defining a rib retained in the arm.

15. The electrical connector is recited in claim 14, wherein a pair of hooks are defined on the front of the upper wall of the rear cover.

16. The electrical connector is recited in claim 15, wherein the basic portion further defines a pair of slits retained the hooks, respectively.

17. An electrical connector comprising:
an insulative housing defining a front mating port and a rear connecting port along a front-to-back direction;
a plurality of contacts side by side arranged with one another in a transverse direction perpendicular to said front-to-back direction, and assembled to the housing, each of the contacts defining a front mating section expose in the front mating port and a rear soldering section exposed in the connecting port;
an insulative spacer assembled in the connecting port and defining a supporting portion with a plurality of grooves therein to respective receive the soldering sections of the corresponding contacts;
a rear insulative cover assembled in the connecting port and opposite to the spacer in a vertical direction perpendicular to both said front-to-back direction and said transverse direction; and
a cable including a plurality of wires mechanically and electrically connected to the corresponding rear soldering sections, respectively; wherein
a rear cover defines a through hole through which the cable extend to an exterior.

18. The electrical connector as claimed in claim 17, wherein interengagement devices are formed on both the housing and the spacer and the rear cover to allow the spacer and the rear cover to be forwardly assembled to the housing in said front-to-back direction, respectively.

19. The electrical connector as claimed in claim 18, wherein said interengagement devices include two pairs of grooves located around two opposite ends along the transverse direction in the connecting port of the housing, and a pair of ribs at two opposite ends along the transverse direction on the rear cover, and another pair of ribs at two opposite ends along the transverse direction on the spacer.

20. The electrical connector as claimed in claim 17, wherein said through hole is located at an end of the rear cover in the transverse direction.
